(19) United States
(12) Patent Application Publication
(10) Pub. No.: US 2023/0356210 A1
(43) Pub. Date: Nov. 9, 2023

(54) METHOD FOR REMOVING ACIDS FROM ORGANIC SOLVENTS

(71) Applicant: Nanoscale Components, Inc., Hudson, NH (US)

(72) Inventors: Joanna L. Sparkes Turteltaub, Mansfield, MA (US); Christopher J. Allen, Charlton, MA (US); Suraj S. Deshpande, Windham, NH (US); Ronald A. Wohl, Woodside, CA (US); Asela Maha Acharige, Brookline, NH (US)

(21) Appl. No.: 18/102,254

(22) Filed: Jan. 27, 2023

Related U.S. Application Data
(60) Provisional application No. 63/303,678, filed on Jan. 27, 2022.

(51) Int. Cl. B01J 49/57; B01J 41/07; B01J 41/12; B01J 39/04; B01J 39/18; B01J 49/53; B01J 49/60; B01D 15/36; B01D 15/20

(52) U.S. Cl. CPC B01J 49/57; B01J 41/07; B01J 41/12; B01J 39/04; B01J 39/18; B01J 49/53; B01J 49/60; B01D 15/363; B01D 15/203; H01M 4/0459

(57) ABSTRACT

The present invention relates to methods of regenerating ion exchange resins in systems using anhydrous organic solvents, such as systems for alkaliating or lithiating materials, such as anodes, in gamma-butyrolactone.

### RELATED APPLICATION

This application claims the benefit of U.S. Provisional Application No. 63/303,678, filed on Jan. 27, 2022. The entire teachings of the above application are incorporated herein by reference.

### BACKGROUND OF THE INVENTION

Methods for prelithiating materials involve the introduction of lithium ions into and/or on a material, such as an anode. One such method includes U.S. Pat. No. 9,598,789 to Grant et al., incorporated herein by reference in its entirety. In one embodiment of the invention, lithium chloride is dissolved in an anhydrous organic solvent, such as gamma-butyrolactone (GBL). At the time the '789 patent was filed, it was believed that the halide ion formed a gaseous by-product (e.g., C12). However, the present inventors have now discovered that the chloride ion released from the salt forms halogenated acidic species, such as halobutyric acid and Hydrogen Chloride (HCl). It is desirable to recycle the anhydrous organic solvent. Therefore, methods of removing acids from organic solvents, particularly anhydrous organic solvents, are needed.

### SUMMARY OF THE INVENTION

The invention is based, in part, on the discovery that halide ions released into an anhydrous organic solvent, such as GBL, during alkaliation forms halogenated acids and other byproducts. The invention relates to methods of removing these acids (and other ionic species) from organic solvents.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates the location of sensors in a column during drying.

FIG. 2 is a chart showing the temperature of the resin over time.

FIG. 3 is a chart of the lithiation fluid pH.

FIG. 4 is a graph illustrating Lithiation dosage consistency as determined in half cell.

FIG. 5A and FIG. 5B are photographs of the resin as received and after 13 use cycles and 6 regeneration cycles.

FIG. 6 is a chart that shows the pH of Process Fluid Purified by Ion-Exchange Column.

### DETAILED DESCRIPTION OF THE INVENTION

The invention is based, in part, on the discovery that halide ions released into an anhydrous organic solvent, such as GBL, during alkaliation forms halogenated acids and other byproducts, such as hydrogen halides. The invention relates to methods of removing these acids from the organic solvent.

Upon appreciation that chlorine gas was not the sole byproduct formed during the alkaliation method of Grant (see the '789 patent), the inventors embarked on a detailed research program. It was then appreciated that the art suffered a long felt need on methods for separating impurities, such as ionic species, from organic solvents, particularly anhydrous organic solvents.

Ion exchange resins are typically used in aqueous purifications. Such resins are commonly regenerated, washed and reused. Several attempts to remove impurities from organic solvents with ion exchange resins are described. For example, U.S. Pat. No. 6,123,850 describes removing impurities with cationic exchange resins, while U.S. Pat. No. 4,831,160 describes the use of anion-exchange media to remove acidic impurities from NMP. Regeneration of ion exchange resins in an anhydrous organic system is problematic. For example, the removal of an acidic impurity from an anionic exchange resin used in an organic system typically requires the addition of water or aqueous solutions for regeneration. However, any water must be completely removed (e.g., the resin is to be dried) before reintroduction of the organic solvent when putting the resin back in service. The failure to remove the water from the resin fouls the organic solvent which, in the case of an alkaliation method, must remain anhydrous. It is known that drying an ion exchange resin can cause bead degradation upon rehydration, a phenomenon called “osmotic shock.” resintech.com/wp-content/uploads/2021/06/Storage-of-Ion-Exchange-Resins.pdf.

The present invention is based on the discovery that ion exchange resins that are dried and then rewetted with anhydrous organic solvents do not suffer from osmotic shock. While this discovery is particularly relevant to processes of lithiating materials for battery production, which requires anhydrous organic solvents, the person of ordinary skill in the art will understand that the discovery has broad applicability in expanding the use of ion exchange resins in a number of organic systems.

The invention relates to a method for regenerating an ion exchange resin comprising an adsorbed ion species and a first organic solvent comprising the steps:
a) adding at least one solution comprising water to the ion exchange resin comprising adsorbed ionic species and organic solvent;
b) removing the water to produce a dried ion exchange resin;
c) wetting the dried ion exchange resin with a second organic solvent.

In a preferred embodiment, the invention relates to a method for regenerating an ion exchange resin comprising an adsorbed ion species and a first organic solvent comprising the steps:
a) regenerating the ion exchange resin comprising adsorbed ionic species and organic solvent with a regenerant, such as an aqueous solution comprising a neutralizing agent (e.g., NaOH);
b) washing the regenerated ion exchange resin with a washing fluid comprising water;
c) removing the water to produce a dried ion exchange resin;
d) wetting the dried ion exchange resin with a second organic solvent.

The first and/or second organic solvent are preferably anhydrous and can be the same or different. In particular, each organic solvent can contain less than 1 vol % water, preferably less than 0.1 vol % water, and more preferably less than 200 ppm water. Each organic solvent can comprise gamma-butyrolactone. In other embodiments, solvents used in electrolyte solutions can be used. For example, butylene carbonate, propylene carbonate, ethylene carbonate, vinylene carbonate, vinyl ethylene carbonate, dimethyl carbonate, diethyl carbonate, dipropyl carbonate, methyl ethyl carbonate, acetonitrile, room temperature ionic liquids, and mixtures thereof can be used.

In addition to solvents typically used in electrolytes or battery manufacturing, the first and/or second organic solvents can be water-immiscible or water miscible organic solvents. The term “water-immiscible” refers to the solvent being incapable of being dissolved in water. Examples of such solvents include halogenated solvents (such as carbon tetrachloride, chloroform, hexachloroethane, 1,1,2-trichloro-1,2,2-trifluoroethane, perfluorocarbons (PFCs), perfluorinated hydrocarbons, perfluorinated amines, perfluorinated ethers, hydrofluorocarbons (e.g., from The Chemours Company, Wilmington, Del., under the trade designation “VERTREL”), and hydrofluoroethers such as methyl perfluorobutyl ether, ethyl perfluorobutyl ether, and those obtained from 3M Company, St. Paul, Minn., under the trade designation “NOVEC 7100” or “NOVEC 7200”, and combinations thereof. Other fluorinated solvents (either partially fluorinated or perfluorinated) may also be useful. In some embodiments, the halogenated solvent is a hydrofluoroether. Acetates and ethers can also be water-immiscible, such as alkyl acetate, alkyl ether, methyl acetate, ethyl acetate, n-propyl acetate, isopropyl acetate, n-butyl acetate, isobutyl acetate, sec-butyl acetate, tert-butyl acetate, n-pentyl acetate, and n-hexyl acetate. Dimethylformamide, N-methyl pyrrolidinone and dimethyl sulfoxide are also common organic solvents. Water-miscible solvents include acetaldehyde, acetic acid, acetone, acetonitrile, cyclohexane, dimethylformamide, dioxane, ethanol, heptane, hexane, methanol, formic acid, ethylamine, dimethyl sulfoxide, pentane, propanol, pyridine, and tetrahydrofuran.

The ionic species to be removed from the organic solvent can be an acid or base and is typically a by-product of a reaction. A preferred reaction involves the alkaliation of a material, such as the lithiation of an electrode, where an alkali salt, or lithium salt, is used. A preferred salt is lithium chloride. In another embodiment, the halide salt is that of Na or K. In another embodiment, the lithium containing salt is LiNO3. Preferred lithium halides are selected from LiCl, LiBr, LiF, and mixtures thereof.

In the process of lithiating a material with lithium chloride in GBL, the byproduct can be hydrogen chloride and/or chlorobutyric acid (CBA). In this embodiment, the acidic species to be removed can be HCl and/or CBA. However, other ionic contaminants (acids or bases) can be removed from organic solvents using the method of the invention. In other words, the process of the invention has broad applicability to the removal of ionic species from organic solvents using ion exchange resins.

Typically, the first organic solvent will contain other unused reactants that one may or may not wish to remove. In the process of alkaliating or lithiating a material, for example, the organic solvent, or GBL, can contain unreacted dissolved lithium chloride or other alkali metal salt. It can be desirable to recycle the unreacted dissolved lithium salt to the lithiation process along with the organic solvent after treatment with the ion exchange resin. Thus, it can be desirable that the ion exchange resin removes less than 50% wt, preferably less than about 10% wt, more preferably less than 1% wt of such alkali metal (lithium) salts. Other components of the lithiation system that one may wish to not remove can include dissolved carbon dioxide. Accordingly, it can be desirable that the ion exchange resin removes less than 50% wt, preferably less than about 10% wt, more preferably less than 1% wt of the dissolved carbon dioxide.

Ion exchange resins are preferably porous materials with functional groups that will bind to, react with or adsorb the ionic species in the organic solvent. For example, the ion exchange resin can comprise tertiary amine functional groups, which can beneficially remove acids. Weak base anion exchange resins (WBA) are typically composed of a porous polymer resin backbone which, when synthesized, forms spherical structures. In general, there are two forms of these polymer backbones: gel ion exchangers which have an acrylic matrix and styrene-divinyl benzene copolymer, or polystyrenic matrix. The polymers are typically cross-linked to provide resin stability. Control of the degree of cross-linking and the use of porogens allows for the tailoring of resin strength, pore structure and pore volume. To the polymer resin backbone, functional groups are added that are capable of sorbing acids without substantially splitting salts. The primary functional groupsof this class of resin are considered weak bases and can include a primary (R—NH₂), secondary (R—NHR′) or tertiary (R—NR′2) amine groups. Additionally, some weak base anion resins may include a minor percentage of strong base (quaternary amine) functional groups. R and R′ groups are substituted or unsubstituted aliphatic or aromatic groups and are preferably lower alkyl groups, such as methyl, ethyl, propyl or butyl. Weak base ion exchange resins are effective in removing chlorinated acids, such as HCl and/or CBA from GBL. Resins selected for this purpose include Aldex WB1, Aldex WB1HC, Aldex WB2, DuPont Amberlite FPA51, DuPont Amberlite FPA52RF, DuPont Amberlite FPA77, DuPont Amberlite FPA77UPS, DuPont Amberlyst A21, DuPont Amberlyst A22, Suzhou Bestion BA765, Suzhou Bestion JKA915, Mitsubishi Diaion WA20, Mitsubishi Diaion WA30, Mitsubishi Diaion WA30C, Ion Exchange India Indion 850, Ion Exchange India Indion 870, Lanxess Lewatit MP62, Lanxess Lewatit MP62WS, Lanxess Lewatit 54328, Lanxess Lewatit 54468, Purolite Purofine PFA123, Purolite Purofine PFA133S, Purolite A100Plus, Purolite A103SPlus, Purolite A109, Purolite A110, Purolite A111, Purolite A111S, Purolite A120S, Purolite A123S, Purolite A133, Purolite A133S, Purolite A835, Resindion Relite A329, Resindion Relite RAM1, Jacobi Carbons Resinex TPX-4503, Jacobi Carbons Resinex TPX-4510, Jacobi Carbons Resinex AB1, Jacobi Carbons Resinex ABlUBOH, Jacobi Carbons Resinex AB2, Jacobi Carbons Resinex AB3, Resintech WBMP, Sunresin Seplite MA940, Thermax Tulsion A2XMP.

In the present invention, process fluid, or organic solvent, contaminated with ionic species, or acid, can be passed along a chemical distribution pathway through column(s) containing weak base ion exchange media positioned within the fluid flow pathway. The pH of entering feedstock fluid (measured by calibrated dilution with water) can be between 2.0 and 6.0; after being passed through ion-exchange media, pH of exiting purified fluid can be between 6.6 and 7.5. After exhaustion of the resin by the contaminated process fluid, the resin is regenerated to restore the functionality. The solution comprising water used to regenerate the ion exchange resin preferably further comprises a counterion relative to the adsorbed ion species, such as NaOH, ammonia, lime or sodium carbonate.

The regeneration step can be performed as in the same direction as the service flow or counterflow configuration.

Weak base ion-exchange resins used for water purification systems can be regenerated through the following general procedure:
Backwash to remove suspended solids and de-compact bed
Treat with regenerant
Treat with water to remove regenerant

To regenerate resins that are used to purify organic solvents, the organic solvent can first be removed from the resin media thereby avoiding waste. After regeneration and before the re-introduction of the organic solvent feedstock, the column can be charged with the organic solvent to drive off the aqueous regeneration fluid and avoid dilution. A typical process for resin used for the purification of organic solvent can be summarized as follows:
Backwash to remove suspended solids and de-compact bed with organic feedstock
Flow water to push out organic solvent from resin media
Treat media with regenerant
Displace regenerant with water
Charge with organic solvent to drive-off water.

In both of these scenarios, the resin remains saturated with fluid throughout the regeneration process and is not dried before reintroduction to the fluid flow pathway. When anhydrous organic solvents are desired, such as for application in electrochemical systems, residual water remaining in the resin can be driven-off before reintroduction of the anhydrous solvent as trace amounts of water entering the fluid pathway will generate additional impurities and will negatively impact the electrochemical reaction.

One known failure mode of ion-exchange resin is termed “osmotic shock”. Through use and regeneration, ion-exchange resins swell and contract. When the swelling or contraction is heterogeneous the resin is subjected to shear forces which may be strong enough to cause cleavage or fracturing resulting in the generation of fine particles. These resulting fine particles reduce resin capacity, increase pressure in the resin bed and reduce overall effectiveness of the purification process. For this reason, resin suppliers recommend and emphasize that ion-exchange resins must not be dried.

However, the current inventors discovered that the methods of the current invention utilizing aqueous alkali regeneration of ion-exchange resins can employ apparatus for drying and select conditions such as temperature, time, air flow, pressure, and electromagnetic radiation, such that resin beads are not damaged and service life is not impacted.

The term “drying” or “dried” in the context of the invention is intended to mean free of water. In one embodiment, the ion exchange resin is dried by driving the water into the atmosphere by, for example, applying heat and/or a vacuum. Oven temperature is typically between 60° C. and 100° C. The preferred temperature is 80° C. Vacuum pressures can range between 200 mTorr and 500 Torr with a preferred pressure of 350 Torr.

In another embodiment, electromagnetic radiation, for example, through use of a microwave, with or without air/gas purge and with or without vacuum, is employed to dry the resin. Microwave frequency may be either 2.45 MHz or between 900 and 930 MHz. For larger scale operation the 900-930 GHz range is preferred. Air/gas flow ranges from 0.2-2 m/s linear velocity and may be up-flow or down-flow through the packing. Vacuum pressure may range between 200 mTorr and 500 Torr with a preferred pressure of 350 Torr.

In another embodiment, the water is driven off by running an organic solvent through the resin until water is detected within acceptable process parameters.

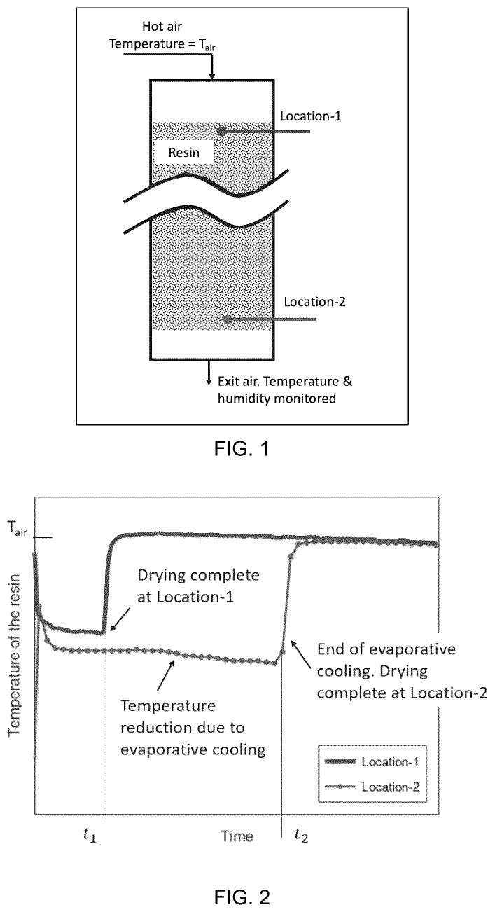

In a preferred embodiment, the resin is dried by flowing air through the ion exchange column at various relative humidity levels from 0.005% to 40% and at various temperatures. Preferred relative humidity is between 0.005% to 5%. Air temperature can range between 25° C. and 100° C. The preferred temperature is 80° C. As the drying front moves from the top of the column to the bottom of the column, sensible heating and evaporative cooling can be measured at two or more positions along the path by thermocouple sensors. FIG. 1. Air temperature is measured by thermocouple. Humidity of exiting air is also monitored. Resin is considered dry when evaporative cooling (recorded with a temperature sensor) at the bottom of the column has ended, and exiting air has essentially the same moisture content as the incoming air. FIG. 2 Brookfield Amtek Comuptrac Vapor Pro water measurement instrument is used to validate dryness of the resin.

Parameters are selected to preserve the integrity and quality of the resin. For example, the dried ion exchange resin can comprise less than 5% wt water, preferably less than 1% wt water and more preferably less than 200 ppm.

A preferred embodiment of the invention includes a method of alkaliating a material in an anhydrous organic solvent comprising the steps:
(a) providing the material;
(b) providing a bath comprising an anhydrous organic solvent having at least one dissolved alkali halide salt, wherein said bath contacts the material, preferably in a continuous process, and wherein a dry gas blanket covers said bath;
(c) providing an electrolytic field plate comprising an inert conductive material wherein said field plate establishes a field between the anode and the field plate; and
(d) applying a reducing current to the anode and an oxidizing current to the field plate, wherein alkali ions from the bath alkaliate into the anode and an anhydrous organic solvent comprising acid byproducts is formed;
(e) contacting the anhydrous organic solvent comprising acid byproducts with an ion exchange resin comprising base groups, or residues, thereby producing an ion exchange resin comprising an adsorbed ion species and an anhydrous organic solvent;
(f) neutralizing, or adding a regenerant (such as a caustic aqueous solution) to, the ion exchange resin;
(g) washing the ion exchange resin with a solution comprising water;
(h) removing the water to produce a dried ion exchange resin;
(i) wetting the dried ion exchange resin with the anhydrous organic solvent to the ion exchange resin.

In this embodiment, ion exchange resins can be used to remove acid byproducts produced by the alkaliation method and improve the recycling of the organic solvent and regeneration of the resin.

Materials for alkaliation can include anodes and cathodes. Such materials can comprise graphite, coke, carbons, tin, tin oxide, silicon, silicon oxide, aluminum, lithium-active metals, alloying metal materials, and mixtures thereof. Materials can also comprise metal oxides of nickel, aluminum, cobalt, manganese, iron, and mixtures thereof. Materials can also comprise sulfur and phosphorus, and mixtures thereof. Materials can also comprise metal substrate (e.g., copper or nickel). Gamma-butyrolactone is a preferred solvent as it dissolves lithium halide, such as lithium chloride. Gamma-butyrolactone has a capable electrochemical window, including the lithium potential near −3 volts vs. a standard hydrogen electrode (SHE). It is a capable electrolyte with high permittivity and low freezing point, and can dissolve and ionize 0.5 M LiCl. A modest amount of heat can be used to reach this value. In one embodiment, the LiCl solution can be maintained at a temperature between about 20° C. and 65° C., such as between 30° C. and 65° C., such as between 38° C. and 55° C. In a more preferred embodiment, the heat is between about 25° C. and 55° C. In a most preferred embodiment, the heat is about 40° C.

The lithiation tank can also have an internal circulating pump and distribution manifold to prevent localized salt concentration deprivation.

Dissolved gas such as CO2 can enhance the lithiation process. It increases the solubility of the salt, the ionic conductivity of the non-aqueous solvent, and increases the efficiency of lithiation. Since CO2 is inexpensive, easily dried, chemically safe, and a potential building block gas for a high quality SEI layer, it has been selected as the preferred dissolved gas. CO2 preferentially reacts with trace H2O and Li^{°} during the lithiation process to form a stable, insoluble SEI material (Li2O, Li2CO3, etc.). The moisture level in the lithiation tank is driven down by the consumption of CO2 and H2O according to this process, and care is given to control the moisture level in the tank to between about 0 to 2000 ppm, preferably 5 to 200 ppm, even more preferably 5 to 100 ppm. In this way, anode lithiation with a quality SEI material is produced continuously.

Deposition of lithium ions (or generally lithiation) from 0.25 to 0.5 M LiCl salt, for example, in gamma-butyrolactone solvent will occur at about 4.1 volts measured between the anode sheet and the reference electrode up to a reducing current density of 2 mA/cm² or more. The preferred current density will vary depending on the nature of the electrode to be lithiated. In order to control both the currents and dependent voltages accurately, it may be necessary to divide the field plate into zones. Other metals can also be alloyed or intercalated or plated with this method including sodium as an example. It was first thought that the lithiation process would release chlorine gas. However, it was then discovered that the chlorine reacted with the solvent and any water present to form HCl and/or an organic acid. Therefore, methods to remove acids from the organic solvent were required.

When the anode is lithiated as described above, it can be assembled into a battery or electrochemical cell with a cathode material. The anode, dried cathode and separator are then assembled into a dried cell housing, such as a button cell housing, a pouch cell, a cylindrical cell or a prismatic cell. Electrolyte is added, and the cell is sealed, preferably during an applied vacuum. Preferred electrolytes include EC/DMC/DEC and 1M LiPF6 and 1% VC. The cell is then sealed (e.g., vacuum sealed) and preferably stored at ambient or elevated temperature (between about 15 and 60° C.) for 1 to 24 hours, preferably between 3 and 18 hours, to allow for electrolyte adsorption and swelling and further SEI formation. The cell is then ready for electrochemical cycling.

### Example 1

Preparation of the Ion-Exchange Resin: A weak base ion-exchange resin, was packed in a glass chromatography column. The resin in the column was then rinsed with de-ionized water until eluting water reached neutral pH and acceptable conductivity. The column was then dried. After drying, the column was charged with anhydrous γ-Butyrolactone (GBL) at a slow rate to avoid packing defects. The resin was allowed to swell in the anhydrous GBL overnight, after which time the column was ready for use.

Use of Weak Base Ion-Exchange Resin for Organic Solvent Purification: Contaminated lithiation process fluid (containing trace CO₂ and acidic chlorinated contaminants) with an entering pH of ˜3, was charged into the column and eluted at a rate of ˜4 mL/min. Fluid exiting column had a pH approaching 7.

To evaluate the effectiveness of the purification, the process fluid was then used to lithiate anode materials according to standard, proprietary processes. The sample process fluid was repeatedly used for lithiation and purified as above until the resin was exhausted, at which point the resin was regenerated.

Resin Regeneration: Argon was used to push bulk process fluid from the column. The column was then rinsed with heated de-ionized water. After rinsing, an aqueous caustic solution (4% NaOH) was passed through the exhausted resin to displace the acid contaminant and restore the weak base functionality to its free base form. A final rinse of the resin with de-ionized water was then conducted until the exiting fluid demonstrated a neutral pH. The column was then dried under vacuum.

In total, one column of resin and one volume of process fluid (GBL/LiCl containing trace CO2) was processed with 13 use/purification cycles which included 6 regeneration steps.

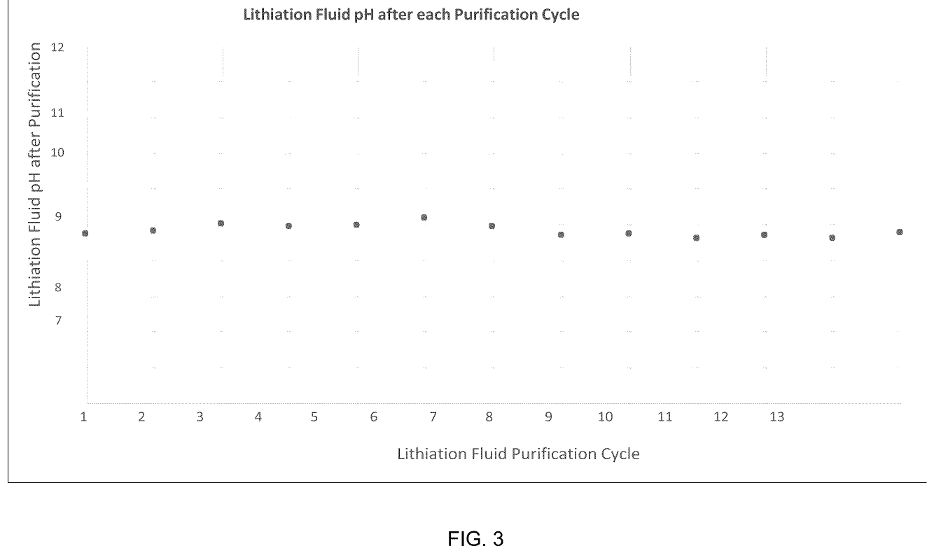

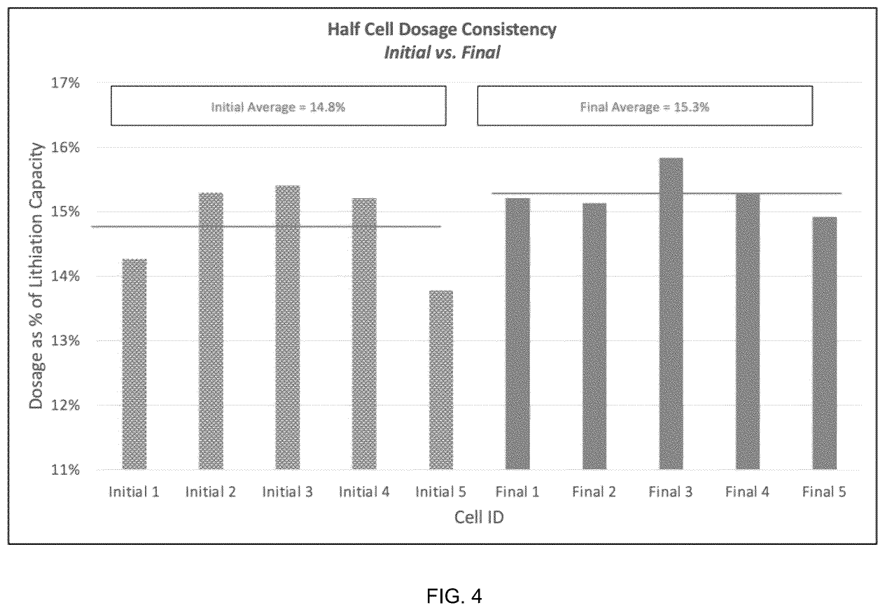

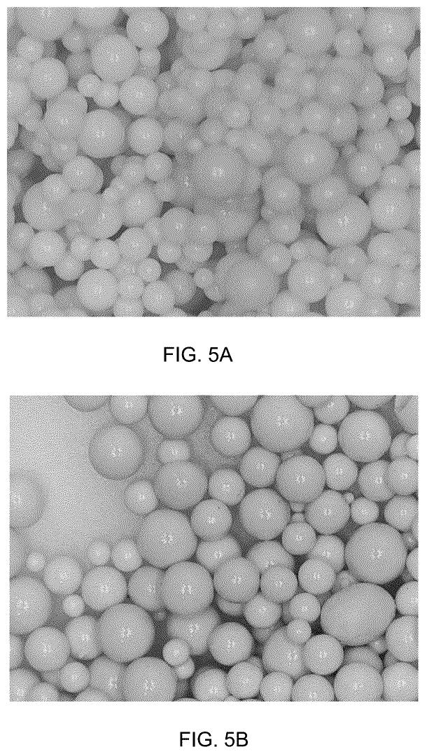

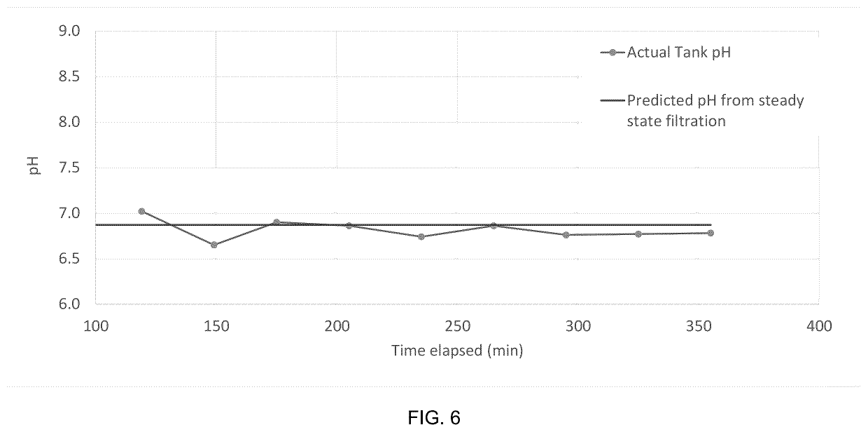

Uniform, neutral fluid pH and lithiation dosage consistency (purification cycle 1 vs. cycle 13) were used to assess the effectiveness of the process fluid purification. FIGS. 3 and 4.

The organic process fluid was sufficiently purified as evidenced by neutral pH and maintenance of lithiation capacity.

Mechanical stability of the weak base ion-exchange resin was assessed by microscopic inspection. No degradation of beads was detected.

### Example 2: Preparation & Usage of Ion Exchange Resin for Fluid Purification at Pilot Scale Filter Preparation

As received resin was packed into a column and washed with DI water in an up-flow configuration to remove suspended solids. DI water rinse was continued until acceptable conductivity of water exiting the column was achieved. Resin was then dried in a vacuum oven to required level before being used for process fluid purification. Anhydrous GBL/LiCl fluid was up-flowed through the column to wet the resin and to allow gas to escape during the wetting process.

### Filter Use:

The filter containing preconditioned weak-base ion exchange resin, wetted with anhydrous GBL/LiCl solution, was placed in the fluid flow pathway in a manner that fluid exiting the prelithiation tank, contaminated with the chloro-acid by-product, was pumped in a down-flow configuration directly through the resin, was purified and recirculated back into the lithiation tank. pH of the process fluid achieved calculated values for steady state filtration of the acidic contaminant species.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

1. A method for regenerating an ion exchange resin comprising an absorbed ion species and a first organic solvent comprising the steps:
a) adding at least one solution comprising water to the ion exchange resin comprising adsorbed ionic species and organic solvent;
b) removing the water to produce a dried ion exchange resin;
c) wetting the dried ion exchange resin with a second organic solvent.

2. The method of claim 1, wherein the first and/or second organic solvent are anhydrous.

3. The method of claim 2, wherein the first and/or second organic solvents contain less than 1 vol % water.

4. The method of claim 1, wherein the first and second organic solvents are the same.

5. The method of claim 1, wherein the first and/or second organic solvents comprise gamma-butyrolactone.

6. The method of claim 1, wherein the dried ion exchange resin comprises less than 5% wt water.

7. The method of claim 1, wherein the absorbed ionic species is an acid.

8. The method of claim 7, wherein the acid is a strong acid.

9. The method of claim 7, wherein the acid is HCl.

10. The method of claim 1, wherein the first organic solvent further comprises alkali metal salts.

11. The method of claim 10, wherein the ion exchange resin removes less than 50% wt.

12. The method of claim 1, wherein the first organic solvent further comprises dissolved carbon dioxide and/or carbonic acid.

13. The method of claim 12, wherein the ion exchange resin removes less than 50% wt.

14. The method of claim 1, wherein the ion exchange resin is porous.

15. The method of acclaim 1, wherein the ion exchange resin comprises tertiary amine functional groups.

16. The method of claim 15, wherein ion exchange resin characterized by a ratio of quaternary ammoniums to tertiary amines of less than 5:100.

17. The method of claim 16, wherein the ion exchange resin is substantially free of quaternary amines.

18. The method of claim 1, wherein the solution comprising water is a regenerant.

19. The method of claim 1, wherein the solution comprising water further comprises NaOH, ammonia or sodium carbonate.

20. The method of claim 1, wherein the adsorbed ion species is substantially removed from the ion exchange resin.

21. The method of claim 1, wherein the step of removing water is performed under vacuum.

22. The method of claim 1, further comprising the step of backwashing the ion exchange resin comprising adsorbed ionic species to remove suspended solids.

23. The method of claim 1, wherein the adsorbed ionic species is a base.

24. The method of claim 23, wherein the ion exchange resin comprises acid functional groups.

25. A method of alkaliating a material in an anhydrous organic solvent comprising the steps:
(a) providing the material;
(b) providing a bath comprising an anhydrous organic solvent having at least one dissolved alkali halide salt, wherein said bath contacts the material, and wherein a dry gas blanket covers said bath;
(c) providing an electrolytic field plate comprising an inert conductive material wherein said field plate establishes a field between the anode and the field plate; and
(d) applying a reducing current to the anode and an oxidizing current to the field plate, wherein alkali ions from the bath alkaliate into the anode and an anhydrous organic solvent comprising acid byproducts is formed;
(e) contacting the anhydrous organic solvent comprising acid byproducts with an ion exchange resin comprising base residues thereby producing an ion exchange resin comprising an adsorbed ion species and an anhydrous organic solvent;
(f) adding a regenerant to the ion exchange resin comprising adsorbed ionic species and organic solvent;
(g) washing the ion exchange resin with an aqueous solution;
(h) removing the water to produce a dried ion exchange resin;
wetting the dried ion exchange resin with the anhydrous organic solvent to regenerate the ion exchange resin.
